(19) United States
(12) Patent Application Publication
(10) Pub. No.: US 2015/0233133 A1
(43) Pub. Date: Aug. 20, 2015

(54) Door Restoration Plug

(71) Applicant: Mina George Ajrab, Bradenton, FL (US)

(72) Inventor: Mina George Ajrab, Bradenton, FL (US)

(21) Appl. No.: 14/580,083

(22) Filed: Dec. 22, 2014

Related U.S. Application Data
(60) Provisional application No. 61/969,072, filed on Mar. 21, 2014.
(60) Provisional application No. 61/940,782, filed on Feb. 17, 2014.

(51) Int. Cl. E04G 23/02; B32B 37/00; E06B 1/52

(52) U.S. Cl. CPC E04G 23/0277; E06B 1/524; B32B 37/0046; B32B 2435/00; B32B 2419/00

(57) ABSTRACT

The invention is prefabricated and configured to repair and restore damage caused to various locations of a door. A method and apparatus are disclosed for the repair and restoration of a door's stile, rail, core or surface. The invention includes a prefabricated door restoration plug that once installed permanently bonds and replaces the damaged door material.

### CROSS-REFERENCES TO RELATED APPLICATIONS

This application claims priority to provisional application No. 61/969,072 filed on Mar. 21, 2014 and provisional application 61/940,782 filed on Feb. 17, 2014.

### STATEMENT REGARDING FEDERALLY SPONSORED RESEARCH OF DEVELOPMENT

Not Applicable.

### MICROFICHE APPENDIX

Not Applicable

### FIELD OF THE INVENTION

This invention relates to a method and system for the repair of exterior or interior doors. Particularly, this invention relates to the bottom, top and edge of doors that have experienced surface or structural degradation. Specifically this invention relates to a novel prefabricated plug for door restoration of doors that repairs the degraded structural elements of a door. This invention consists of a method and system of door restoration or repair.

### BACKGROUND OF THE INVENTION

Certain doors are manufactured with wood, fiberglass, composites and weather resistant material that degrade in similar areas on a door. Environmental conditions can cause damage to doors including excessive water exposure, termite and burrowing pest activity, dry rot, fungus, physical abuse and more. The environmental conditions that damage doors mostly occur below the lowest hinge. For most doors this damage occurs along the stile near bottom six to eight inches. The rest of the door is still structurally sound. Direct weather contact can also damage the top edge, inner edge or outer edge of a door.

Conventional methods of door repair include:

1. Two part epoxies or auto body fillers: This may work for a period of time but if insect activity is present then there is a high likelihood burrowing pests will return. Continual patching and filling becomes a constant routine until there isn't any suitable door material to patch left.

2. Replacing the damaged door structural material: This is usually performed by a skilled carpenter. Swapping out non-standardized structural elements in a door quickly becomes too complicated for the average handyman and skilled labor costs will likely outpace the cost of door replacement.

3. Door replacement: This is usually done by a skilled carpenter and possibly a licensed contractor in some areas. Installing a new door brings with it higher material and labor costs, possible building permits, delivery requires you have a large vehicle. Some downsides include complexity of installation such as needing specialty tools like hole-saws, chisels, routers, hinge fitments, locks, latches, often forgotten is the replacement of security system door sensors and more. The reasons some may not replace their door because it may have sentimental value, intricate unique glasswork, or unique door designs. The often forgotten environmental impact is disposing a door with less than 5% damage or is still 95% good into our landfills. A repair method is needed that allows cost effective repair method for doors instead of the hassle of door replacement.

### SUMMARY OF THE INVENTION

The present invention is defined by the appended claims with specific embodiments being shown in the attached drawings. For the purpose of summarizing the invention, the invention relates to a repair method of a door.

In a more specific example of the invention includes a method that centers around the use of a prefabricated door restoration plug used to replace only the damaged portion of a door. A prefabricated door plug can vary in shape and size to target specific damage over a range of doors. The thickness of the plug can match the door surface usually 1.75 inches, rail or stile usually 1.25 inches and the height and width can vary with each application. In addition this invention includes a method of repair that includes the preparation of the damaged door to install the door restoration plug. The installer will need standard tools and to follow the method and install the door restoration plug.

The construction of the door restoration plug consists of weather resistant materials such as pressure treated wood, hardwood, polyvinyl chloride, thermoplastics and others in the shape of the targeted area of repair. The plug features multiple fastener options including dowels, hot dipped galvanized nails, stainless steel nail and joint connectors.

The invention also includes a method for the preparation of the door to receive the prefabricated door restoration plug. The preparation of the door includes varying installation steps from specific cuts with template holes to be drilled into the door to receive the door restoration plug. After the door has been prepared then a permanent bond is achieved thru the use of the adhesives specified in the method which can include polyurethane adhesives, polyvinyl alcohol adhesives and others.

### REFERENCE NUMERALS IN THE DRAWINGS

2,4,7 rail, surface and stile door restoration plug with dowel(s)
20,24 rail, surface and stile door restoration plug with dowel(s) and mechanical fastener(s)
6,19,23 targeted plug with repair locations on door
11,13,26,29 stile and surface corner door restoration plug with dowel(s) and mechanical fastener(s) stile, surface and corner door restoration plug with dowels
10,12,21,25 targeted plug with repair locations on door stile and rail replacement insert with dowels stile replacement insert with dowel and mechanical fastener
17,28 stile replacement insert with dowel(s) or mechanical fastener(s)
8,14,16,27,29 targeted plug with repair locations on door method for the restoration of doors

### BRIEF DESCRIPTION OF THE DRAWINGS

A visual understanding of the features of the invention summarized above is provided with the use of the appended drawings, which illustrate the method and system of the invention and therefore, are not to be considered as limiting its scope with regard to other applications which the application is capable of targeting.

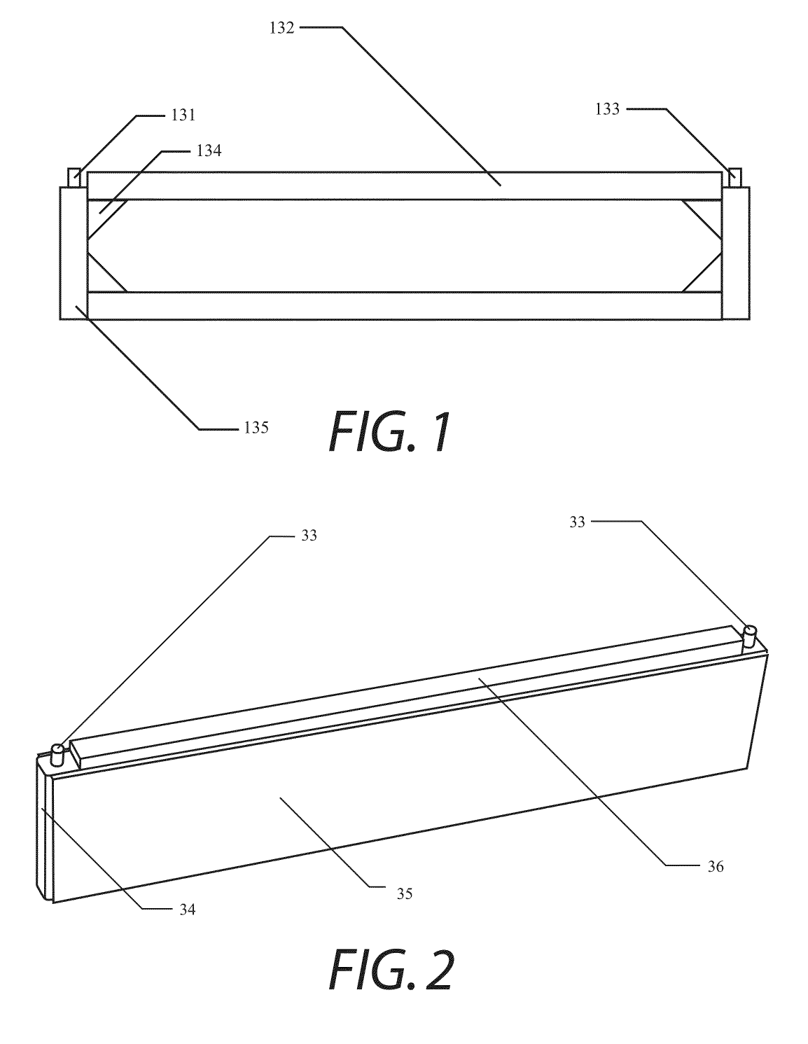

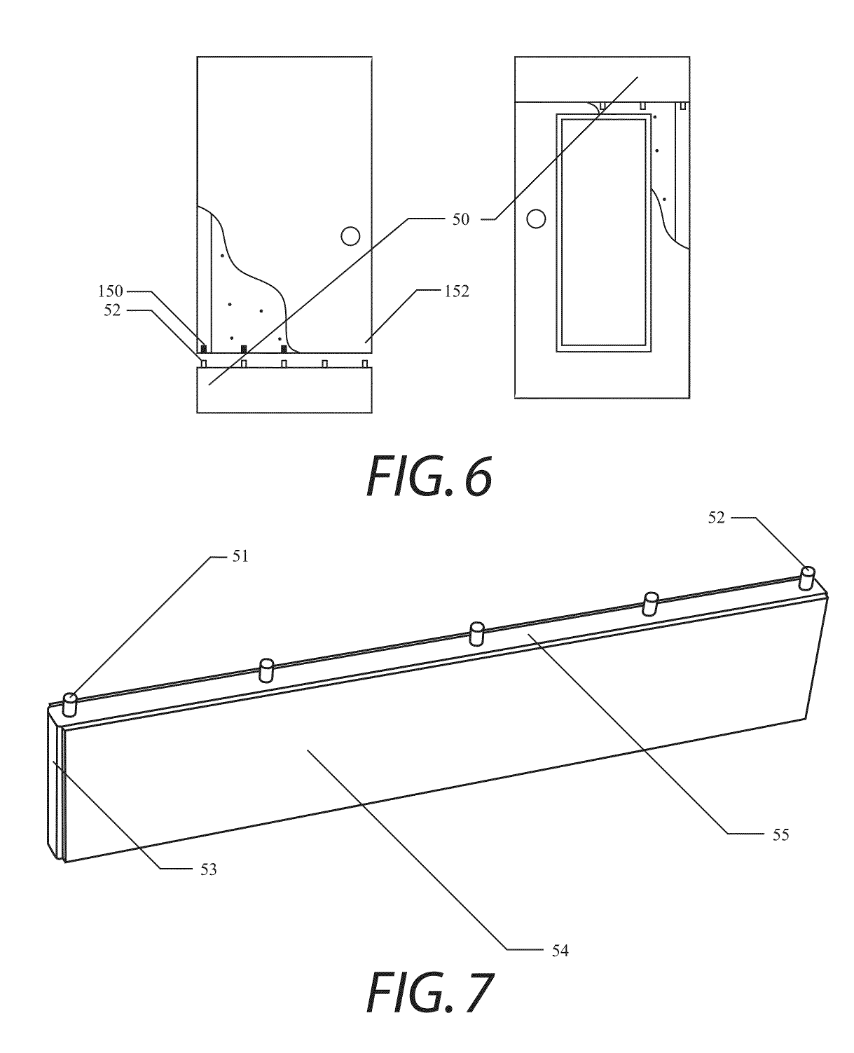

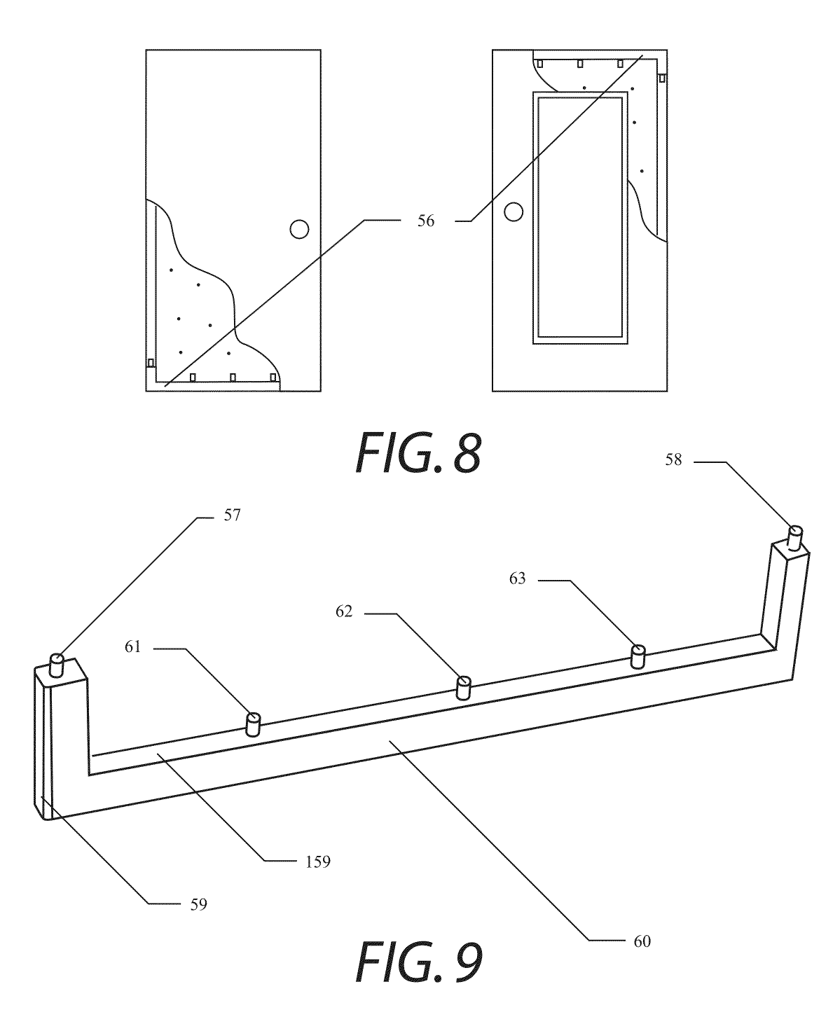

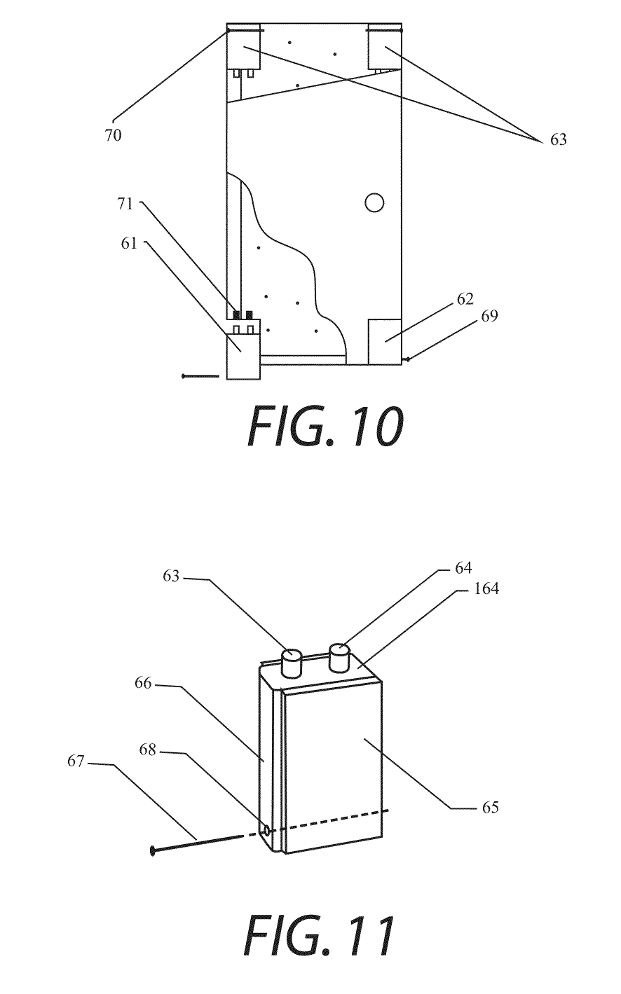

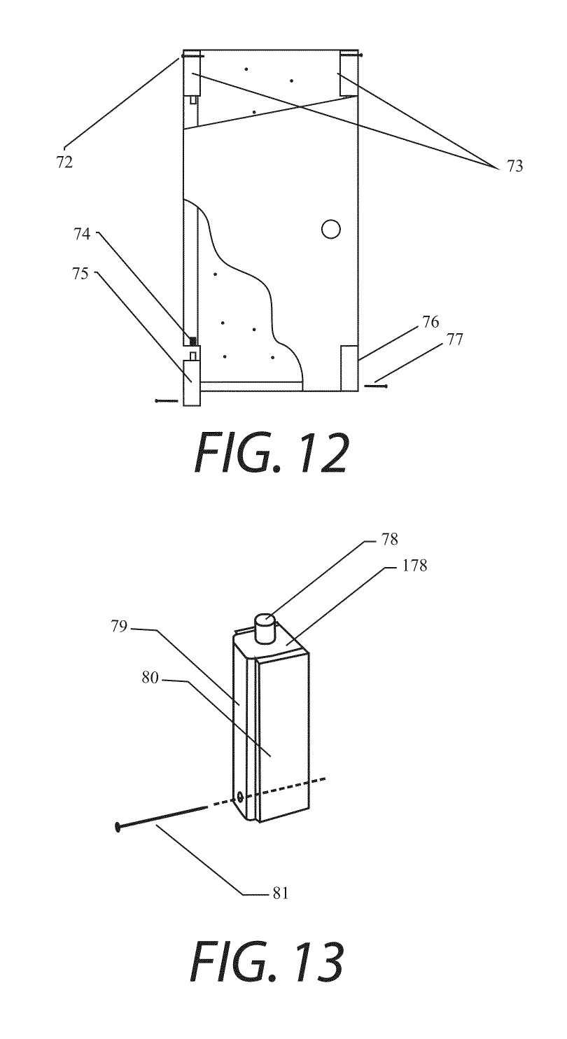

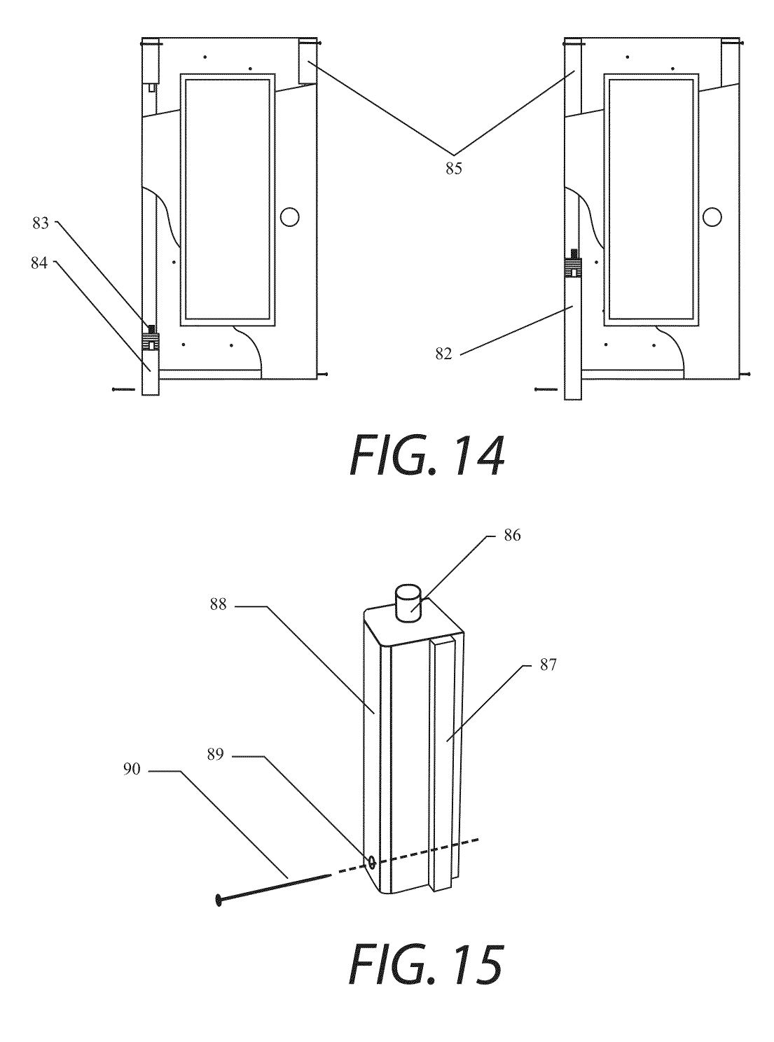

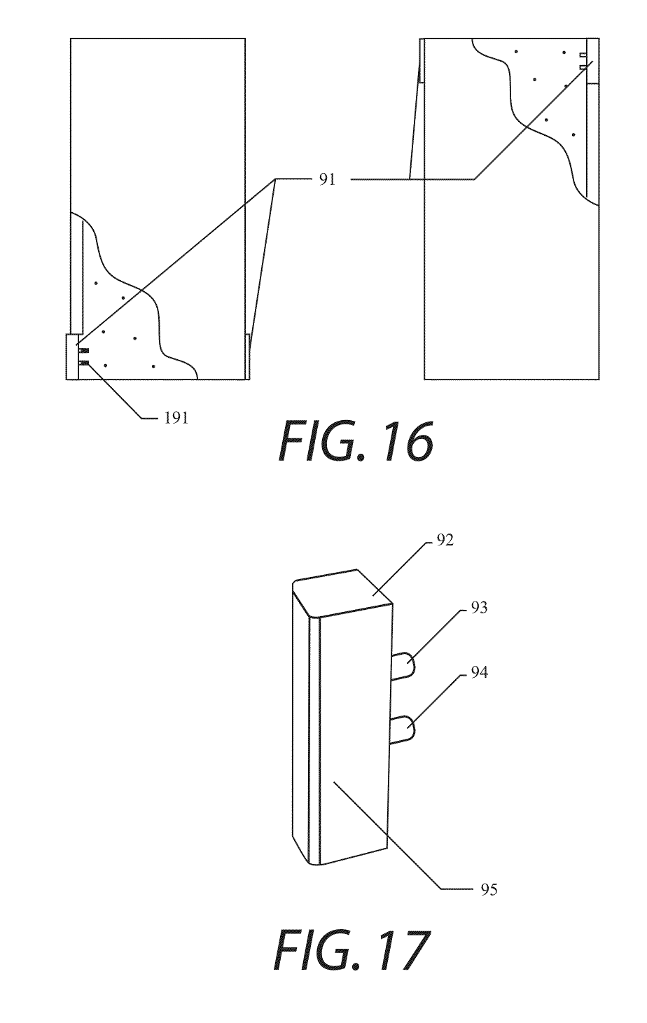

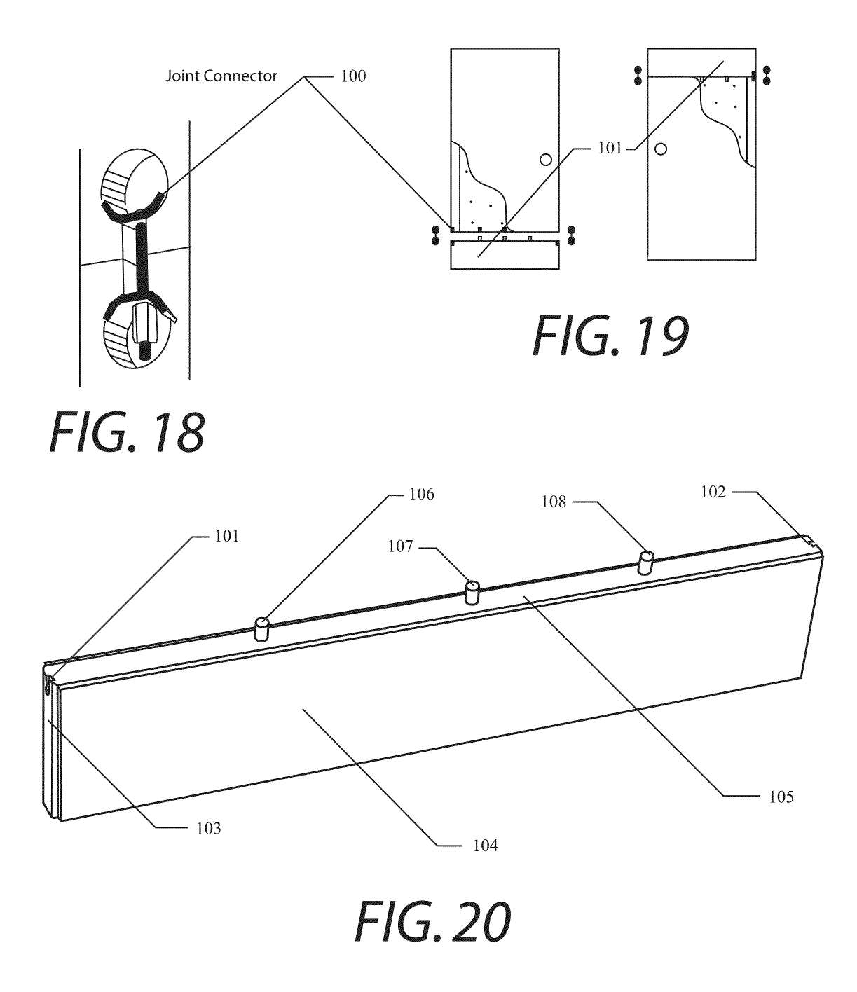

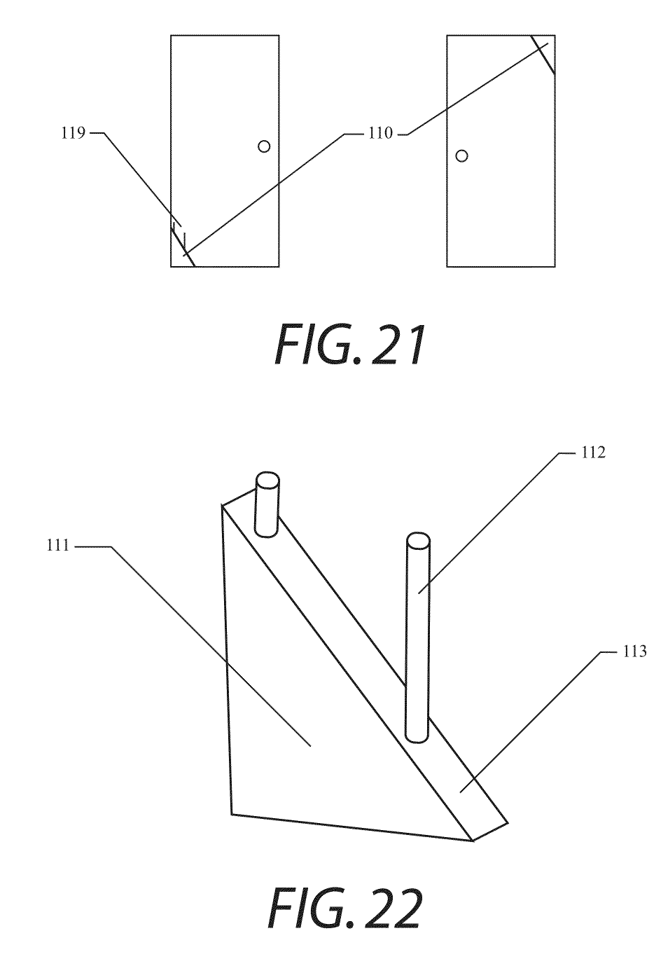

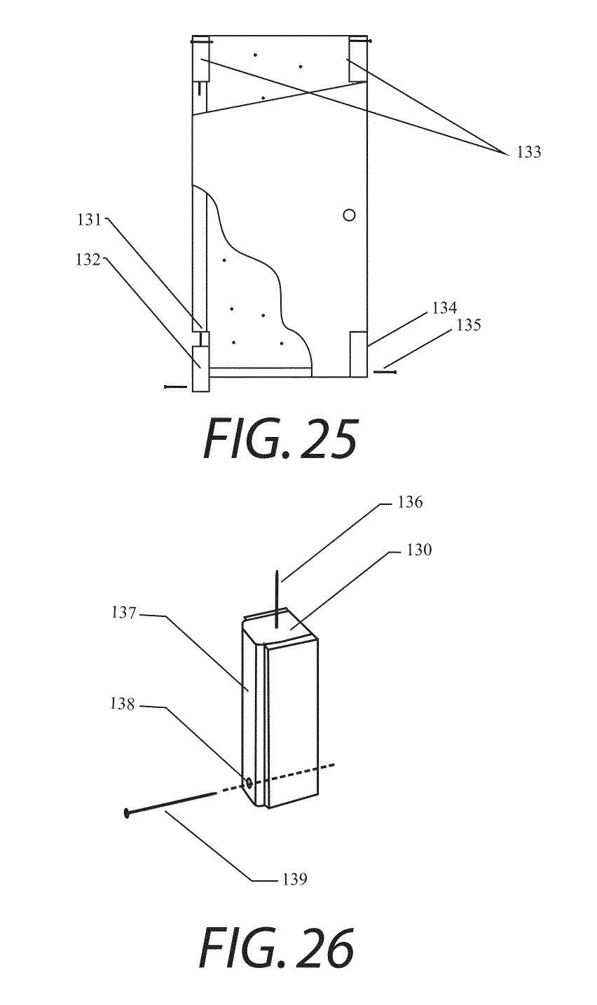

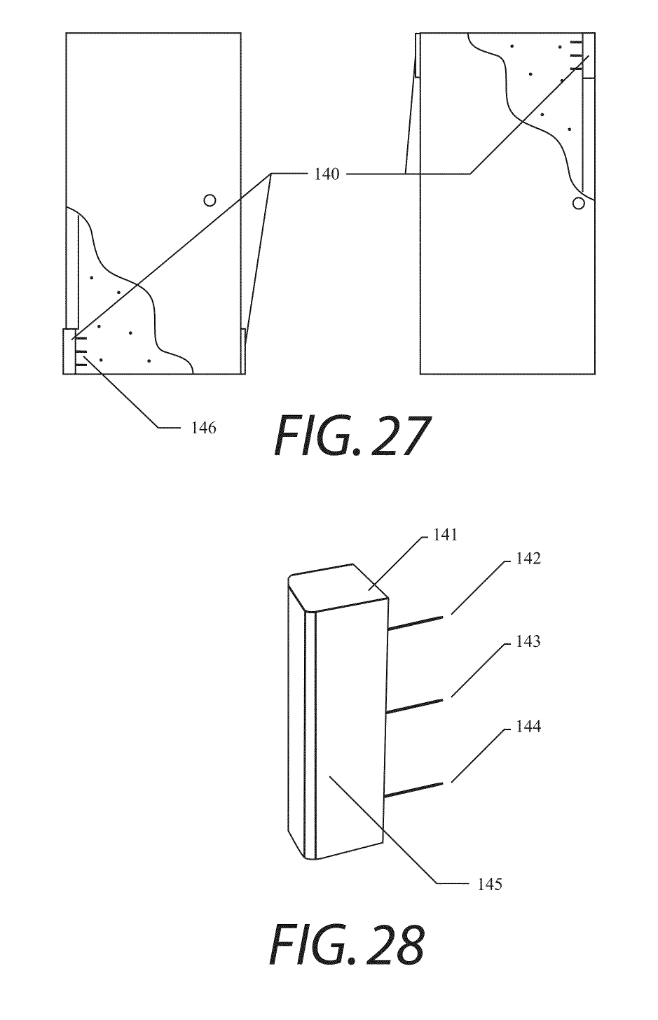

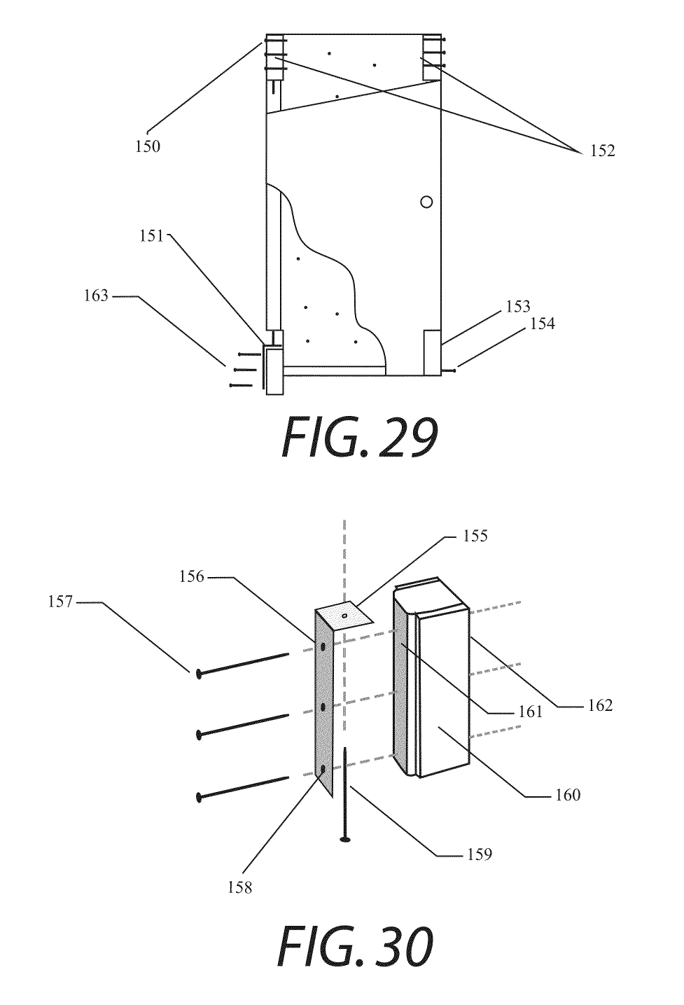

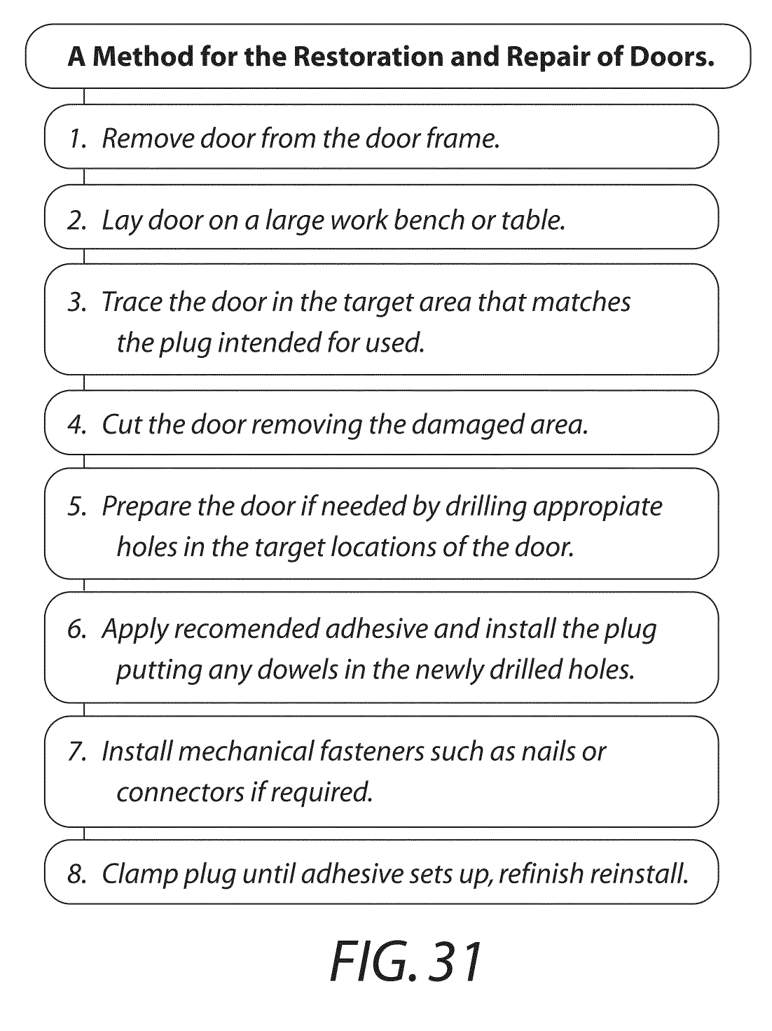

FIG. 1-30 illustrates different types of prefabricated door restoration plugs and/or the target location of repair on different types of doors. FIG. 1-5 Illustrates one version of a bottom or top restoration plug. FIG. 6,7 illustrates another version of a bottom or top restoration plug and the door location. FIG. 8, 9 illustrates a lower profile version of a bottom or top restoration plug and the door location. FIG. 6, 7 illustrates another version of a bottom or top restoration plug and the door location. FIG. 10, 11 illustrates a version of a corner restoration plug and the door location. FIG. 12, 13 illustrates another version of a corner restoration plug and the door location. FIG. 14, 15 illustrates a version of a corner stile restoration plug or insert with varied lengths to suit different levels of damage to a door and the door location. FIG. 16, 17 illustrates another version of a corner stile restoration plug and the door location targeted for repair. FIG. 18-20 illustrates another version of a bottom or top restoration plug and the door location. FIG. 21, 22 illustrates another version of a corner restoration plug and the door location targeted for repair. 23, 24 illustrates another version of a bottom or top restoration plug and the door location targeted for repair. FIG. 25, 26 illustrates another version of a corner restoration plug and the door location. FIG. 27, 28 illustrates a version of a corner stile restoration plug and the door location targeted for repair. FIG. 29, 30 illustrates another version of a corner restoration plug and the door location targeted for repair. FIG. 31 displays the step by step method for restoration and repair of doors using this particular door restoration plug.

FIG. 1 is a frame made with pressure treated wood or structural foam.

FIG. 2 top of the frame 36 protrudes ¾ of an inch above the flush line to create a male fitment area into the door notch to be prepared. The left 34 and right edges extend outward to match the existing stile profile of the door to be restored. The laminated panel applied to both sides 35 of the plug.

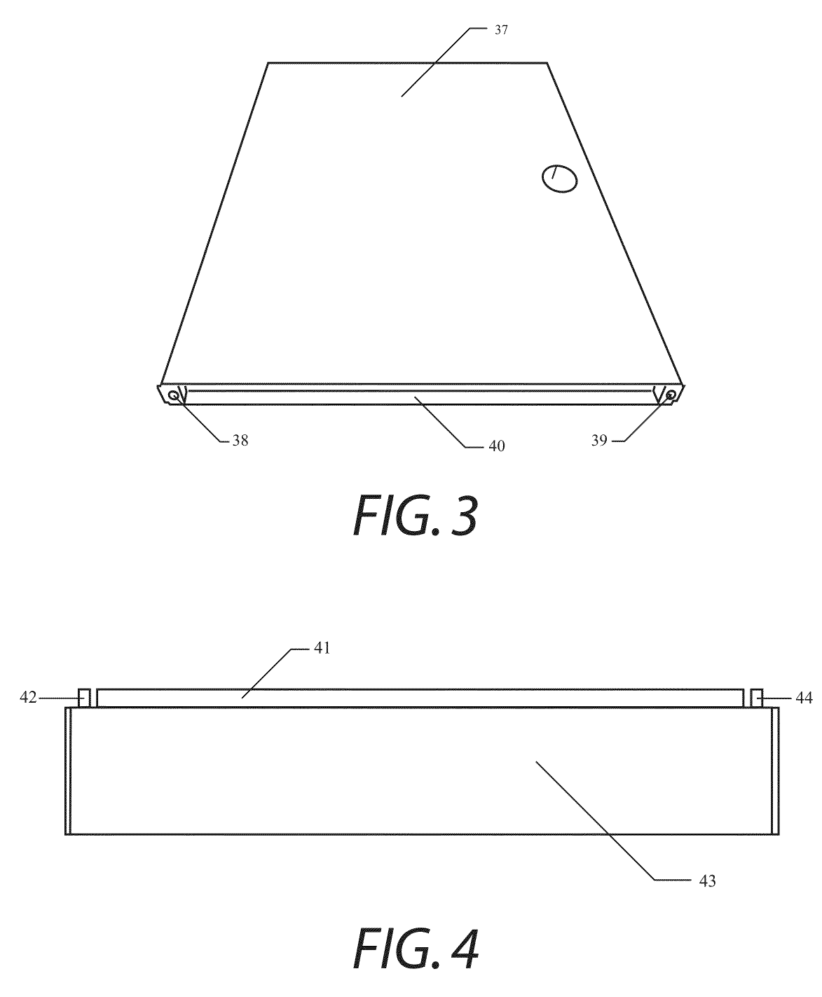

FIG. 3 The door 37 has been prepared by cutting the bottom (or top) of the door off (not illustrated) and the ½ inch holes 38,39 have been drilled and the notch 40 has been created by removing the core material.

FIG. 4 is a straight on view of the rail, surface and stile door restoration plug.

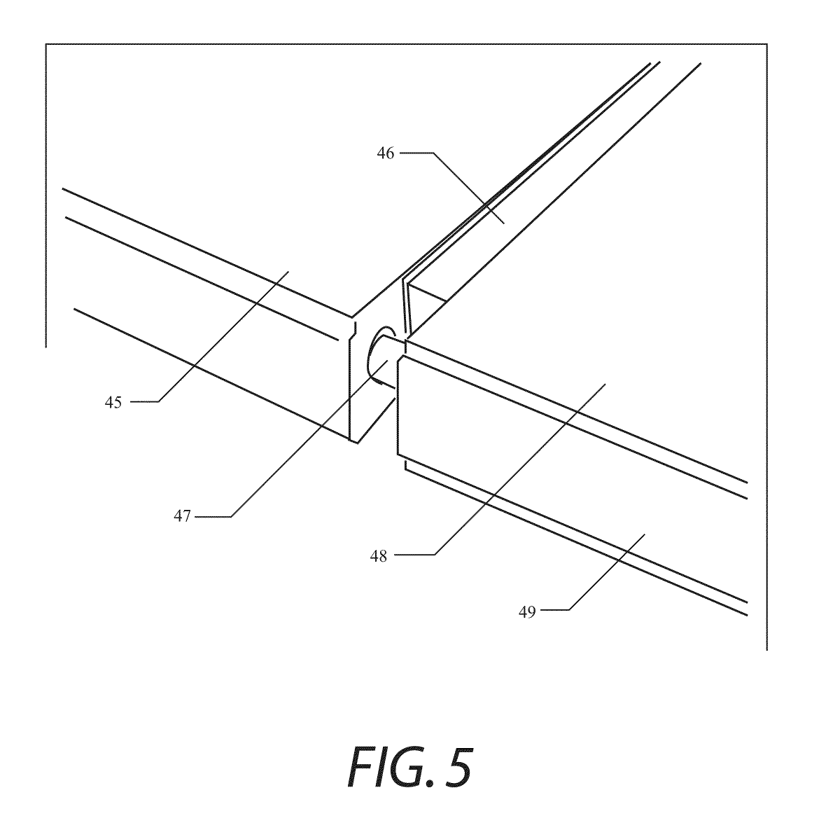

FIG. 5 you can see the detail of the plug fitting correctly into the prepped door. Final permanent bond includes a polyurethane foam adhesive.

FIG. 6 shows the placement locations either the door top or door bottom 50 of a dowel only rail, surface and stile door restoration plug.

FIG. 7 shows the detail and profile of the dowel only rail, surface and stile door restoration plug 54. Construction consists of pressure treated wood laminated to create one solid piece or a molded structural foam mold constructed piece. Dowels 51 are ½ inch in diameter and extrude ¾ inches past the flush line.

FIG. 8 shows the placement locations either the door top or door bottom 56 of a dowel only rail and stile door restoration plug.

FIG. 9 shows the detail and profile of the dowel only rail and stile door restoration plug 64. Construction consists of pressure treated wood or a molded structural foam mold constructed piece. Dowels 57, 61,62,63,58 are ½ inch in diameter and extrude ¾ inches.

FIG. 10 shows the placement locations either the door top corners 63 or door bottom corners 61, 62 of a rail, surface and stile door restoration plug. Preparation is accomplished by removing a corner of the door and drilling two ½ inch holes 71 at a depth ¾ inch.

FIG. 11 shows rail, surface and stile door restoration plug with mechanical fastener 67.

FIG. 12 shows the placement locations either the door top corners 73 or door bottom corners 75, 76 of a rail, surface and stile door restoration plug. Preparation is accomplished by removing a corner of the door and drilling one ½ inch hole 74 at a depth ¾ inch.

FIG. 13 shows rail, surface 80 and stile 79 door restoration plug with mechanical fastener 81.

FIG. 14 shows the placement locations either the door top corners 85 or door bottom corners 84 of a stile replacement insert with dowel and mechanical fastener 82.

FIG. 15 shows the stile 88 replacement insert with dowel 86 and mechanical fastener 90.

FIG. 16 shows targeted door locations of repair with stile replacement insert with dowels on door.

FIG. 17 shows stile replacement 95 insert with dowels 93,94

FIG. 18 shows a side detail of a joint connector 100 the mechanical fastener used to fasten the stiles of the door and replacement plug.

FIG. 19 shows the placement locations either the door top or door bottom 101.

FIG. 20 shows a close up of the rail, surface and stile door restoration plug with dowels 106,107,108 and mechanical fasteners. This plug requires the use of a joint connector located at 101 and 102 to clamp the plug end to end with the door top or bottom FIG. 19—101

FIG. 21 shows the placement locations of the stile, surface and corner door restoration plug with dowels 110. The triangle shape is a feature that targets corner damage occurring on any of the four corners of a door.

FIG. 22 shows the stile, surface and corner door restoration plug with dowels 111 with a triangle shape to minimize the amount of door surface being repaired while targeting the common damage areas of a door.

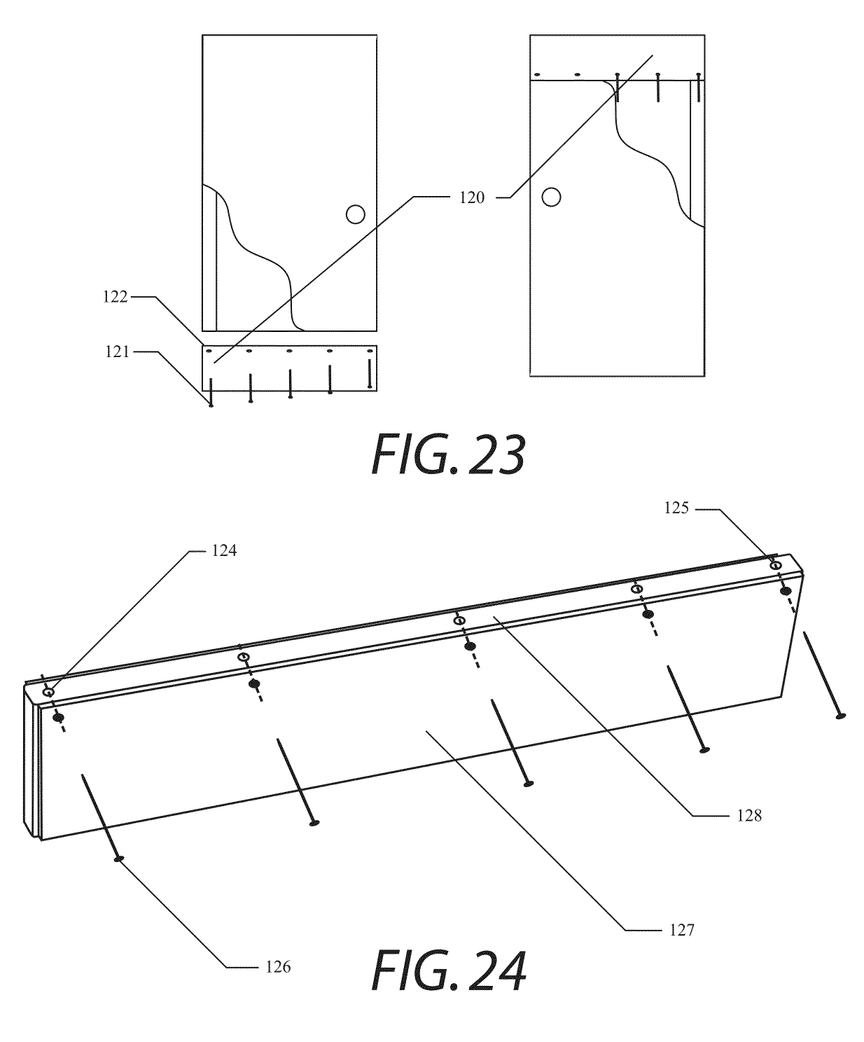

FIG. 23 shows targeted plug with repair locations both top and bottom on door 120

FIG. 24 shows rail, surface and stile door restoration plug with mechanical fasteners 127. In this illustration the mechanical fastener that is used to assist in a permanent bond is a hot dipped galvanized nail thru an angle drilled holes 124,125.

FIG. 25 shows targeted plug with repair locations on door.

FIG. 26 shows stile and surface corner door restoration plug 137 with mechanical fastener 136,139.

FIG. 27 shows targeted insert with repair locations with cutouts on door 133,132. Installation in achieved by measuring the template height then removing the damage door stile material. Then to line up the insert and install 140 by using adhesive and a hammer.

FIG. 28 shows stile replacement insert 145 with mechanical fasteners 142,143,144 hot galvanized dipped nails.

FIG. 29 shows targeted plug with repair locations on door with cutouts 132,153,150.

FIG. 30 shows stile and surface corner door restoration plug 160, mechanical fasteners 157, 159 a metal strap 156 made from stainless steel with holes 156,158 and stainless steel nails 157,159. Installation of the metal strap to the door stile is the first step then the plug is lined up flush, adhesive applied and then the three nails 157 are hammered into the plug joining it permanently to the door.

FIG. 30 shows the method for the restoration of doors.

### DETAILED DESCRIPTION OF THE INVENTION

FIG. 1 shows the profile of the construction of the rectangular frame of the door restoration plug. For foam filled wooden stile or edge doors, the rail, surface and stile door restoration plug consisting of wood treated with micronized copper azole and then fastened with triangle support wedges and polyurethane adhesive. Half inch holes are drilled to a depth of ¾ inches on the top left and right 30 portion of the frame. Wooden dowels are installed and cemented permanently with polyurethane adhesive.

FIG. 2 shows a perspective view of a complete door restoration plug along fully constructed with laminated paneling 35.

FIG. 3, 4 at this time the door is taken down and placed horizontally on a large work bench or table, first the bottom or top of the door will get a straight cut across the width of the door with a circular saw using a fence to ensure the cut is straight. Then two half inch holes 38, 39 and notch in the core of the door 40 at a depth of ¾ inches matching the protruded dimensions of the plug are made.

FIG. 5 a dry fit is needed to ensure that the plug 48 fits flush snuggly and completely plumb into the door 45. Once the confirmation of a successful dry fit then the application of a polyurethane adhesive is applied in the areas 47, 46 both the door and the door restoration plug. Then the plug is joined to the door and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 6, 7 show locations on a door 50 where the door restoration plug 54 can be used. For installation the door is taken down and placed horizontally on a large work bench or table, first the bottom or top of the door will get a straight cut across the width of the door with a circular saw using a fence to ensure the cut is straight. Then two half inch holes are drill in the left and right stiles 150,152 and the three holes are drilled in the core of the door. After a dry fit a polyurethane adhesive is applies to the five dowels 51 and joining surface 55. Then the plug constructed of either solid wood or structural foam is joined to the door and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 8, 9 show locations on a door 56 where the door restoration plug 60 can be used. For installation the door is taken down and placed horizontally on a large work bench or table, first the bottom or top of the door will get a combination cut across the width of the door with a jig saw and circular saw using a fence to ensure the cut is straight. Then two half inch holes are drill in the left and right stiles on the door and the three holes are drilled in the core of the door. After a dry fit a polyurethane adhesive is applies to the five dowels 57, 61,62,63,58 and joining surface 159. Then the plug constructed of either solid wood or structural foam is joined to the door and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 10, 11 show locations on a door 63, 62, 61 where the door restoration plug 65 can be used. For installation the door is taken down and placed horizontally on a large work bench or table, first the rectangular corner of the door will get a combination cut across then lengthwise with a saw using a fence to ensure the cut is straight. Then two half inch holes are drilled in the door 71. After a dry fit a polyurethane adhesive is applies to the two dowels 63, 64 and joining surface 164. Then the plug constructed of either solid wood or structural foam is joined to the door and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 12, 13 show locations on a door 73, 75, 76 where the door restoration plug 80 can be used. For installation the door is taken down and placed horizontally on a large work bench or table, first the rectangular corner of the door will get a combination cut across then lengthwise with a jig saw and circular saw using a fence to ensure the cut is straight. Then one half inch hole is drilled in the door 74. After a dry fit a polyurethane adhesive is applies to the dowel 78 and joining surface 178. Then the plug constructed of either solid wood or structural foam is joined to the door and it will be necessary to secure the plug with clamps and masking tape until the adhesive sets up. The hot dipped galvanized or stainless steel nail will then get hammered into the rail of the door creating an instantly secure bond. The plug is permanently installed into the door creating a permanent bond. Once the polyurethane adhesive is dry the door is ready for any cosmetic touch ups, paint and re-installation onto the door frame.

FIG. 14, 15 show locations on a door 85, 84, 82 where the stile restoration insert 88 can be used. For installation the door is taken down and placed horizontally on a large work bench or table, first the damaged stile material will be removed with a combination of tools such as a chisel and hammer. Important to note the original surface of the door will not be removed just the stile. Then one half inch hole is drilled in the door 83. After a dry fit a polyurethane adhesive is applies to the dowel 86 and joining surface 87. Then the plug constructed of either solid wood or structural foam is joined to the door and it will be necessary to secure the plug with clamps and masking tape until the adhesive sets up. The hot dipped galvanized or stainless steel nail will then get hammered into the rail of the door creating an instantly secure bond. The plug is permanently installed into the door creating a permanent bond. Once the polyurethane adhesive is dry the door is ready for any cosmetic touch ups, paint and re-installation onto the door frame.

FIG. 16, 17 show locations on a door 91 where the stile restoration insert 95 can be used. For installation the door is taken down and placed horizontally on a large work bench or table, first the damaged stile material will be removed with a combination of tools such as a chisel and hammer. Important to note the original surface of the door will not be removed just the stile. Then two half inch hole is drilled in the door core 191. After a dry fit a polyurethane adhesive is applies to the dowel 93, 94 and joining surface 92. Then the plug constructed of either solid wood or structural foam is joined to the door and it will be necessary to secure the plug with clamps and masking tape until the adhesive sets up. The hot dipped galvanized or stainless steel nail will then get hammered into the rail of the door creating an instantly secure bond. The plug is permanently installed into the door creating a permanent bond. Once the polyurethane adhesive is dry the door is ready for any cosmetic touch ups, paint and re-installation onto the door frame.

FIG. 18, 19, 20 show locations on a door 101 where the door restoration plug 104 can be used. For installation the door is taken down and placed horizontally on a large work bench or table, first the bottom or top of the door will get a cut across the width of the door with a circular saw using a fence to ensure the cut is straight. Then two half inch holes are drill in the left and right side of the stiles on the door 100 and the three holes are drilled in the core of the door. After a dry fit a polyurethane adhesive is applies to the three dowels 106,107,108 and joining surface 105. Then the plug constructed of either solid wood or structural foam is joined to the door including the installation of the stile joint connector fastener and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 21, 22 show locations on a door 21 where the door restoration plug 111 can be used. For installation the door is taken down and placed horizontally on a large work bench or table, first the bottom or top corner of the door will get a cut across using a circular saw using a fence to ensure the cut is straight. Then two half inch hole is drilled in the door stile and core 119. After a dry fit a polyurethane adhesive is applied to the dowels 112 and joining surface 113. Then the plug constructed of either solid wood or structural foam is joined to the door and it will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 23, 24 show locations on a door 120 where the door restoration plug 104 can be used. For installation the door is taken down and placed horizontally on a large work bench or table, first the bottom or top of the door will get a cut across the width of the door with a circular saw using a fence to ensure the cut is straight. After a dry fit a polyurethane adhesive is applied. Then a clamp will be used to keep plug After a dry fit a polyurethane adhesive is applies in place while the nail are hammer thru the pre drill angled holes 124 into the door. The plug constructed of either solid wood or structural foam is permanently installed into the door creating a permanent bond. Once the polyurethane adhesive is dry the door is ready for any cosmetic touch ups, paint and re-installation onto the door frame.

FIG. 25, 26 show locations on a door 133,132,134 where the door restoration plug 137 can be used. For installation the door is taken down and placed horizontally on a large work bench or table, first the rectangular corner of the door will get a combination cut across then lengthwise with a jig saw and circular saw using a fence to ensure the cut is straight. After a dry fit a polyurethane adhesive is applies to the joining surface 130. Then the plug constructed of either solid wood or structural foam is joined to the door by first hammering the spike 136 into the stile of the door 131. It will be necessary to secure the plug with clamps and masking tape until the adhesive sets up. The hot dipped galvanized or stainless steel nail will then get hammered into the rail of the door creating an instantly secure bond. The plug is permanently installed into the door creating a permanent bond. Once the polyurethane adhesive is dry the door is ready for any cosmetic touch ups, paint and re-installation onto the door frame.

FIG. 27, 28 show locations on a door 140 where the door restoration plug 145 can be used. For installation the door is taken down and placed horizontally on a large work bench or table, first the rectangular corner of the door will get a combination cut across then lengthwise with a jig saw and circular saw using a fence to ensure the cut is straight. After a dry fit a polyurethane adhesive is applies to the joining surface 141. Then the plug constructed of either solid wood or structural foam is joined to the door by hammering the hot dipped galvanized or stainless steel spikes 142,143,144 into the core of the door 146. It will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 29, 30 show locations on a door 152,153 where the door restoration plug 160 can be used. For installation the door is taken down and placed horizontally on a large work bench or table, first the rectangular corner of the door will get a combination cut across then lengthwise with a jig saw and circular saw using a fence to ensure the cut is straight. After a dry test fit a stainless steel or hot dipped galvanized strap will be installed 151 first using a nail 159 driven into the stile of the door. Then polyurethane adhesive is applies to the joining surface 162. Then the plug 160 constructed of either solid wood or structural foam is joined to the door by hammering the hot dipped galvanized or stainless steel spikes 157 into the core and rail of the door 163. It will be necessary to secure the plug with clamps and masking tape until the adhesive sets up. The plug is permanently installed into the door creating a permanent bond. Once the polyurethane adhesive is dry the door is ready for any cosmetic touch ups, paint and re-installation onto the door frame.

FIG. 31 show the method for the restoration of doors being claimed.

Having described my invention, I claim:

1. A method for the restoration of doors comprising:
a) A prefabricated door restoration plug configured for door repair and restoration of damage of a door stiles, door rails and door surfaces b) Targeting damage caused to the inner and outer stiles and both top and bottom rail of a door. c) Targeting damage to the core of a door. d) Targeting damage to the surface area of a door. e) The use of the adhesives specified in each method which can include polyurethane adhesive, polyvinyl alcohol adhesive and others. f) Installation method with step by step instructions.

2. A prefabricated door bottom and top door restoration plug apparatus comprising:
a) Common thickness of the targeted door. b) Male or female attachment connectors. c) Hardware that can include hot dipped galvanized, composite and stainless steel nails or other hardware. d) Configured profile shape, width and height of door restoration apparatus for targeted door.

3. A prefabricated stile door restoration plug repair apparatus comprising:
a) Predetermined male shape profile with a dowel for the replacement of a damaged door stile. b) Hardware that can include hot dipped galvanized, composite and stainless steel nails or other hardware. c) The use of the adhesives specified in each method to create a permanent bond which can include polyurethane adhesive, polyvinyl alcohol adhesive.

4. A prefabricated door rail repair apparatus comprising:
a) Predetermined male shape profile with a dowel for the replacement of a damaged door rail. b) Hardware that can include hot dipped galvanized, composite and stainless steel nails or other hardware. c) The use of the adhesives specified in each method to create a permanent bond which can include polyurethane adhesive, polyvinyl alcohol adhesive.

5. A prefabricated door corner repair apparatus comprising:
a) Predetermined profile shape with fasteners for the replacement of a damaged door corner. b) Hardware that can include hot dipped galvanized, composite and stainless steel nails or other hardware. c) The use of the adhesives specified in each method to create a permanent bond which can include polyurethane adhesive, polyvinyl alcohol adhesive.
